(19) United States
(12) Patent Application Publication
(10) Pub. No.: US 2026/0370614 A1
(43) Pub. Date: Nov. 19, 2026

(54) MINING NETWORK SLICING METHOD AND SYSTEM

(71) Applicant: CCTEG CHINA COAL RESEARCH INSTITUTE, BEIJING (CN)

(72) Inventors: WENZHEN WU, BEIJING (CN); YUAN FU, BEIJING (CN); CHUNXIAN WEI, BEIJING (CN); LIYA ZHANG, BEIJING (CN); WENBO JI, BEIJING (CN); CHENXIN LI, BEIJING (CN); GUOWEI YANG, BEIJING (CN); YUFENG JIANG, BEIJING (CN); YINJIE HE, BEIJING (CN)

(21) Appl. No.: 19/136,372

(22) PCT Filed: Oct. 26, 2023
(86) PCT No.: PCT/CN2023/126870

§ 371 Date: Jun. 6, 2025

(30) Foreign Application Priority Data
Dec. 6, 2022 (CN) 202211557887.5

(51) Int. Cl. H04L 47/80; H04L 12/42; H04L 41/0896

(52) U.S. Cl. CPC H04L 47/805; H04L 12/42; H04L 41/0896; H04L 47/808

(57) ABSTRACT

A mine network slicing method includes: obtaining respective slices corresponding to a mine transmission network by slicing the mine transmission network according to a predetermined slice type, in which the slice type includes a reserved service slice; determining a total bandwidth of the mine transmission network; determining a number of terminals in a service system accessing the mine transmission network and bandwidth metrics of transmission services at respective terminals; determining a bandwidth of each of the respective slices according to the number of terminals in the service system accessing the mine transmission network and the bandwidth metrics of transmission services at respective terminals, and the total bandwidth of the mine transmission network; in which the service system accessing the mine transmission network includes a plurality of terminals.

### CROSS-REFERENCE TO RELATED PATENT APPLICATION

The present disclosure is a US national phase application of International Application No. PCT/CN2023/126870, filed on Oct. 26, 2023, which claims a priority to Chinese Patent Application No. 2022115578875 filed in China on Dec. 6, 2022, the entire content of which is incorporated herein by reference.

### FIELD OF THE DISCLOSURE

The present disclosure relates to a field of network slice, particularly to a mine network slicing method and a system, and a computer-readable storage medium.

### BACKGROUND OF THE DISCLOSURE

Types of underground mining services are increasing as advancement of intelligent construction of coal mines, and an industrial ring network based on traditional Ethernet technology will no longer be able to meet service demands.

In the traditional Ethernet technology, traffic between services of different security levels is transmitted through interconnected interfaces. There is no technical solution for on-demand resource allocation and effective channel isolation. In addition, the traditional Ethernet uses a “Best Effort” forwarding strategy, without considering service transmission quality (quality of service, QoS) and differentiated demands of mine service types at the beginning of design. Therefore, the industrial ring network based on traditional Ethernet technology neither has an ability to allocate resources according to service demands, nor can effectively guarantee a transmission performance of high-priority services.

### SUMMARY OF THE DISCLOSURE

According to a first aspect of embodiments of the present disclosure, there is provided a mine network slicing method. The method includes:
obtaining respective slices corresponding to a mine transmission network by slicing the mine transmission network according to a predetermined slice type, in which the slice type includes a reserved service slice;
determining a total bandwidth of the mine transmission network;
determining a number of terminals in a service system accessing the mine transmission network and bandwidth metrics of transmission services at respective terminals;
determining a bandwidth of each of the respective slices according to the number of terminals in the service system accessing the mine transmission network and the bandwidth metrics of transmission services at respective terminals, and the total bandwidth of the mine transmission network;
in which, the service system accessing the mine transmission network includes a plurality of terminals;
determining the bandwidth of each of the respective slices according to the number of terminals in the service system accessing the mine transmission network and the bandwidth metrics of transmission services at respective terminals, and the total bandwidth of the mine transmission network includes: determining a predetermined bandwidth ratio of the reserved service slice and a predetermined total bandwidth of other slices in the mine transmission network excluding a bandwidth of the reserved business slice, determining the bandwidth of the reserved service slice based on the predetermined bandwidth ratio of the reserved service slice and the predetermined total bandwidth of the other slices in the mine transmission network excluding the bandwidth of the reserved service slice, and determining a bandwidth of each of other slices in the mine transmission network excluding the reserved service slice according to the bandwidth of the reserved service slice, terminal data corresponding to the respective slices, the bandwidth metrics of transmission services at respective terminals and the total bandwidth of the mine transmission network, in which the predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

According to a second aspect of embodiments of the present disclosure, there is provided a mine network slicing system. The system includes:
a memory, a processor and a computer program stored on the memory and capable of being run on the processor, in which, the processor is configured to obtain respective slices corresponding to a mine transmission network by slicing the mine transmission network according to a predetermined slice type, in which, the slice type includes a reserved service slice;
determine a total bandwidth of the mine transmission network;
determine a number of terminals in a service system accessing the mine transmission network and bandwidth metrics of transmission services at respective terminals;
determine a bandwidth of each of the respective slices according to the number of terminals in the service system accessing the mine transmission network and the bandwidth metrics of transmission services at respective terminals, and the total bandwidth of the mine transmission network;
in which, the service system accessing the mine transmission network includes a plurality of terminals;
the processor is further configured to: determining a predetermined bandwidth ratio of the reserved service slice and a predetermined total bandwidth of other slices in the mine transmission network excluding a bandwidth of the reserved business slice, determining the bandwidth of the reserved service slice based on the predetermined bandwidth ratio of the reserved service slice and the predetermined total bandwidth of the other slices in the mine transmission network excluding the bandwidth of the reserved service slice, and determining a bandwidth of each of other slices in the mine transmission network excluding the reserved service slice according to the bandwidth of the reserved service slice, terminal data corresponding to the respective slices, the bandwidth metrics of transmission services at respective terminals and the total bandwidth of the mine transmission network, in which the predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

According to a third aspect of embodiments of the present disclosure, there is provided a computer-readable storage medium storing computer instructions, which cause a computer to implement a mine network slicing method. The method includes:
obtaining respective slices corresponding to a mine transmission network by slicing the mine transmission network according to a predetermined slice type, in which the slice type includes a reserved service slice;
determining a total bandwidth of the mine transmission network;
determining a number of terminals in a service system accessing the mine transmission network and bandwidth metrics of transmission services at respective terminals;
determining a bandwidth of each of the respective slices according to the number of terminals in the service system accessing the mine transmission network and the bandwidth metrics of transmission services at respective terminals, and the total bandwidth of the mine transmission network;
in which, the service system accessing the mine transmission network includes a plurality of terminals;
determining the bandwidth of each of the respective slices according to the number of terminals in the service system accessing the mine transmission network and the bandwidth metrics of transmission services at respective terminals, and the total bandwidth of the mine transmission network includes: determining a predetermined bandwidth ratio of the reserved service slice and a predetermined total bandwidth of other slices in the mine transmission network excluding a bandwidth of the reserved business slice, determining the bandwidth of the reserved service slice based on the predetermined bandwidth ratio of the reserved service slice and the predetermined total bandwidth of the other slices in the mine transmission network excluding the bandwidth of the reserved service slice, and determining a bandwidth of each of other slices in the mine transmission network excluding the reserved service slice according to the bandwidth of the reserved service slice, terminal data corresponding to the respective slices, the bandwidth metrics of transmission services at respective terminals and the total bandwidth of the mine transmission network, in which the predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

### BRIEF DESCRIPTION OF THE DRAWINGS

The above and/or additional aspects and advantages of the present disclosure will become obvious and easy to understand from the following description of the embodiments in conjunction with the accompanying drawings, in which:

FIG. 1 is a flowchart illustrating a mine network slicing method provided in an embodiment of the present disclosure;

FIG. 2 is a schematic diagram illustrating a network architecture of a mine network slicing method provided in an embodiment of the present disclosure;

FIG. 3 is a schematic diagram illustrating data transmission of a slice at data link layer provided in an embodiment of the present disclosure;

FIG. 4 is a schematic diagram illustrating a first architecture of a mine network slicing system provided in an embodiment of the present disclosure;

FIG. 5 is a schematic diagram illustrating a second architecture of a mine network slicing system provided in an embodiment of the present disclosure;

FIG. 6 is a schematic diagram illustrating an architecture of a third determination module provided in an embodiment of the present disclosure;

FIG. 7 is a schematic diagram illustrating a third architecture of a mine network slicing system provided in an embodiment of the present disclosure;

FIG. 8 is a schematic diagram illustrating a fourth architecture of a mine network slicing system provided in an embodiment of the present disclosure.

### DETAILED DESCRIPTION OF THE EXEMPLARY EMBODIMENTS

Embodiments of the present disclosure are described in detail below, and examples of embodiments are illustrated in the accompanying drawings, in which the same or similar labels represent the same or similar elements or elements with the same or similar functions. The embodiments described below with reference to the drawings are exemplary, are intended to be configured to explain the present disclosure and are not to be construed as a limitation of the present disclosure.

The present disclosure provides a mine network slicing method and system, an electronic device, a computer-readable storage medium, a computer program product, and a computer program. The method includes: obtaining respective slices corresponding to a mine transmission network by slicing the mine transmission network according to a predetermined slice type, in which the slice type includes a reserved service slice; determining a total bandwidth of the mine transmission network; determining a number of terminals in a service system accessing the mine transmission network and bandwidth metrics of transmission services at respective terminals; determining a bandwidth of each of the respective slices according to the number of terminals in the service system accessing the mine transmission network and the bandwidth metrics of transmission services at respective terminals, and the total bandwidth of the mine transmission network; in which, the service system accessing the mine transmission network includes a plurality of terminals. The technical solution provided in embodiments of the present disclosure may map mine network slices based on common hierarchical classification and specific demands to achieve channel isolation, effectively guarantee a transmission performance of high-priority services, and thus help accelerate intelligent construction of coal mines.

A mine network slicing method and system, an electronic device, a computer-readable storage medium, a computer program product, and a computer program according to embodiments of the present disclosure are described with reference to the accompany drawings.

### Embodiment One

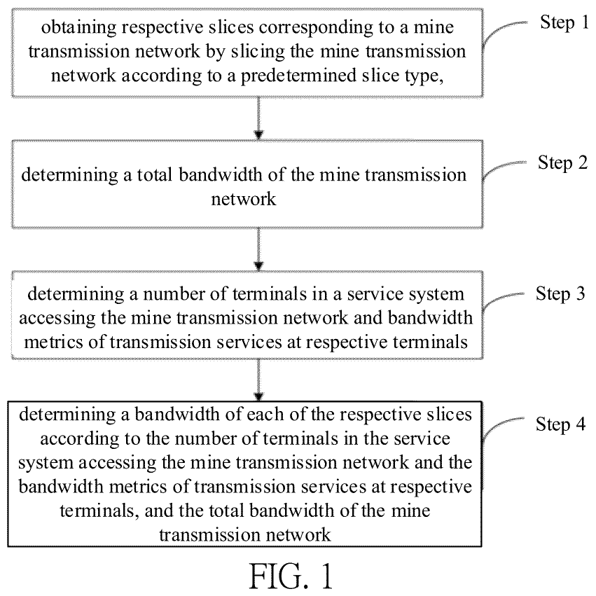

FIG. 1 is a flowchart illustrating a mine network slicing method provided in an embodiment of the present disclosure. As illustrated in FIG. 1, the method includes block 1 to block 4.

At block 1, respective slices corresponding to a mine transmission network are obtained by slicing the mine transmission network according to a predetermined slice type.

In an embodiment of the present disclosure, the slice type includes a low-latency service slice, a large-bandwidth service slice, an industrial ring network service slice, and a reserved service slice.

Alternatively, the slice type includes at least one the low-latency service slice, the large-bandwidth service slice, the industrial ring network service slice, the reserved service slice, a high-priority service slice, a high-reliability service slice, a high-coordination service slice or a remote control service slice.

It should be noted that names of the slices are not limited to this expression. Slices with other names but the same functions and indicators are also within the scope of protection. For example, the industrial ring network service slice may also be a regular service slice, a general priority service slice, etc.

In some embodiments, the service system accessing the mine transmission network includes at least one of:
a mine security monitoring system, a mine video monitoring system, a mine WIFI communication system, a mine 4G communication system, a mine 5G communication system, a mine positioning system, a mine broadcasting system, a mine dispatching and command system, a mine cellular direct communication system, a mine 5G camera system, a mine hydrological monitoring system, a mine pressure monitoring system, a mine automatic air door system, a mine primary conveyor belt system or a mine power supply system.

It is noted that, before the block 1, the method further includes:
obtaining an upper latency threshold value and a bandwidth demand value of each transmission service corresponding to the service system accessing the mine transmission network in a case that the service system accessing the mine transmission network includes at least one of the mine security monitoring system, the mine video monitoring system, the mine WIFI communication system, the mine 4G communication system, the mine 5G communication system, the mine positioning system, the mine broadcasting system, the mine dispatching and command system, the mine cellular direct communication system, or the mine 5G camera system.

In some embodiments, the block 1 specifically includes:
mapping a transmission service with an upper latency threshold value of the transmission service less than or equal to a predetermined latency threshold value and a bandwidth demand value of the communication service less than a predetermined bandwidth threshold value in the mine security monitoring system, the mine video monitoring system, the mine WIFI communication system, the mine 4G communication system, the mine 5G communication system, the mine positioning system, the mine broadcasting system, the mine dispatching and command system, and the mine cellular direct communication system to the low-latency service slice.

In some embodiments, before transmitting the service, it is defined a 5QI (5G QoS Indicator) of the mine transmission network, that is, an indication of a group of data flows between a marked terminal of the 5G network and a core network, including priority, packet delay or packet error rate, or a QCI (QoS Class Identifier) scale value, a delay threshold value L and a bandwidth threshold value Bt. When dividing slices, the transmission service with the upper latency threshold value of the transmission service less than or equal to the predetermined latency threshold value L and the bandwidth demand value of the communication service less than the predetermined bandwidth threshold value Bt in the mine security monitoring system, the mine video monitoring system, the mine WIFI communication system, the mine 4G communication system, the mine 5G communication system, the mine positioning system, the mine broadcasting system, the mine dispatching and command system, and the mine cellular direct communication system is mapped to the low-latency service slice.

It should be noted that the above-mentioned mine security monitoring system, the mine video monitoring system, the mine WIFI communication system, the mine 4G communication system, the mine 5G communication system, the mine positioning system, the mine broadcasting system, the mine dispatching and command system, and the mine cellular direct communication system all carry services related to coal mine safety production, emergency command, etc., therefore, the low-latency slice only performs mapping to the low-latency service slice on the services carried by the above-mentioned systems.

A transmission service with a bandwidth demand value of the transmission service greater than or equal to the predetermined bandwidth threshold value and that have not been mapped to the low-latency service slice in the mine video monitoring system, the mine 5G camera system, the mine WIFI communication system, the mine 4G communication system, the mine 5G communication system, the mine-used cellular direct communication system is mapped to the large-bandwidth service slice.

In some embodiments, the transmission service with the bandwidth demand value of the transmission service greater than or equal to the predetermined bandwidth threshold value Bt and that have not been mapped to the low-latency service slice in the mine video monitoring system, the mine 5G camera system, the mine WIFI communication system, the mine 4G communication system, the mine 5G communication system, the mine-used cellular direct communication system is mapped to the large-bandwidth service slice.

A transmission service that has not been mapped to the low-latency service slice in the mine security monitoring system, the mine hydrological monitoring system, the mine pressure monitoring system, the mine automatic air door system, the mine primary conveyor belt system or the mine power supply system is mapped to the industrial ring network service slice.

An evolved service in the mine transmission network is mapped to the reserved service slice.

It is note that the reserved service slice is provided in order to reserve resources facilitating to expanding service types such that, configuration of the existing network will not be affected when a capacity of the system is expanded.

Each slice communicates end-to-end during data transmission, without processing by a switch midway.

In some embodiments, the block 1 further includes:
mapping a present service in the mine transmission network to the high-priority service slice, the high-reliability service slice, the high-coordination service slice or the remote control service slice.

The present service includes a specific high-priority service, a specific high-reliability service, a specific high-coordination service or a specific remote control service.

At block 2, a total bandwidth of the mine transmission network is determined.

It should be noted that the mine transmission network in an embodiment supports a deployment scheme of network slicing. The mine transmission network includes at least one surface core switch and at least one underground ring network switch. The surface core switch and the underground ring network switch use a BGbps optical fiber interface to form a ring network. A model number of the switch may be KJJ83(D). The switch is an explosion-proof and intrinsically safe network interface for mining, B is the total bandwidth, with a maximum value of 100 Gbps or 50 Gbps.

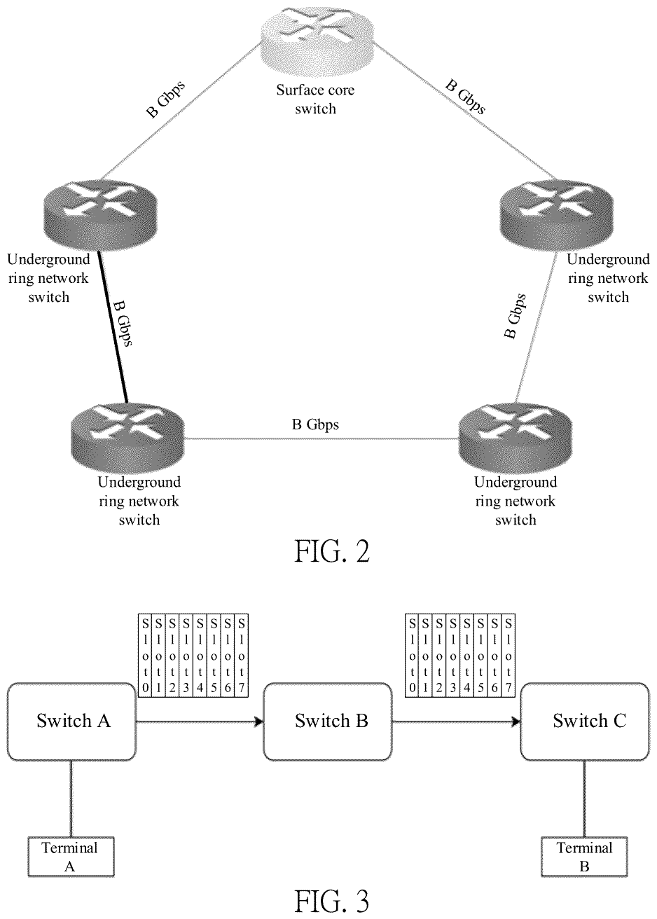

In some embodiments, as illustrated in FIG. 2, a networking architecture of the mine transmission network include one surface core switch and four underground ring network switches, and the mine transmission network slicing solution of this embodiment is deployed in the mine transmission network.

At block 3, a number of terminals in a service system accessing the mine transmission network and bandwidth metrics of transmission services at respective terminals are determined.

At block 4, a bandwidth of each of the respective slices is determined according to the number of terminals in the service system accessing the mine transmission network and the bandwidth metrics of transmission services at respective terminals, and the total bandwidth of the mine transmission network.

In an embodiment of the present disclosure, the block 4 specifically includes block 4-1 to block 4-3.

At block 4-1, a predetermined bandwidth ratio of the reserved service slice and a predetermined total bandwidth of other slices in the mine transmission network excluding a bandwidth of the reserved business slice are determined.

The predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

At block 4-2, the bandwidth of the reserved service slice is determined based on the predetermined bandwidth ratio of the reserved service slice and the predetermined total bandwidth of the other slices in the mine transmission network excluding the bandwidth of the reserved service slice.

In some embodiments, the block 4-2 specifically includes:
in response to B′≤(1−n)B, determining that the bandwidth of the reserved service slice is equal to a product of the predetermined bandwidth ratio of the reserved service slice and the total bandwidth of the mine transmission network;
in response to B′>(1−n)B, determining that the bandwidth of the reserved service slice is equal to a difference between the total bandwidth of the mine transmission network and the total bandwidth of the other slices in the mine transmission network excluding the bandwidth of the reserved service slice;
where B′ is the predetermined total bandwidth of the other slices in the mine transmission network excluding the bandwidth of the reserved service slice, B n=0.25, n is the predetermined bandwidth ratio of the reserved service slice, B is the total bandwidth of the mine transmission network.

In some embodiments, the bandwidth of the reserved service slice is determined as follows.

The bandwidth of the reserved service slice is directly determined according to a preset ratio n and preset results of other slices, and the determination method includes followings.

Let the weights of other slices in the mine transmission network excluding the reserved service slice be equal to 1, and the calculated total bandwidth of other slices in the mine transmission network excluding the reserved service slice is denoted as B′;
in a case of B′≤(1−n)*B, the bandwidth of the reserved slice is n*B; otherwise, the bandwidth of the reserved service slice is B-B′, and the total bandwidth of other slices is (1−n)*B, where B is the total bandwidth, and n=0.25.

At block 4-3, a bandwidth of each of other slices in the mine transmission network excluding the reserved service slice is determined according to the bandwidth of the reserved service slice, terminal data corresponding to the respective slices, the bandwidth metrics of transmission services at respective terminals and the total bandwidth of the mine transmission network.

In response to B′≤(1−n)B, the bandwidth of each of the other slices in the mine transmission network excluding the reserved service slice is determined by using a formula

$${B}_{i} = {\sum }_{q = 1}^{Q} {\sum }_{n = 1}^{W} {B}_{q , w} ;$$

in response to B′>(1−n)B, the bandwidth of each of the other slices in the mine transmission network excluding the reserved service slice is determined by using a formula

$${B}_{i} = {\sum }_{q = 1}^{Q} {B}_{q} {p}_{q} ; where {\sum }_{i = 1}^{l} {B}_{i} = ( 1 - n ) * B ,$$

where Bᵢ is a bandwidth of an i-th slice in the mine transmission network excluding the reserved service slice, B_{q,w} is a bandwidth metric of a transmission service at a w-th terminal in a q-th service system, Q is a total number of service systems in the slice, W is a total number of terminals in one service system, B_{q} is a bandwidth metric average of transmission services at respective terminals in the q-th service system, p_{q} is a weight corresponding to the q-th service system;
in which, the bandwidth metric average is determined based on bandwidth metrics of transmission services at respective terminals.

In some embodiments, the bandwidth of each of other slices in the mine transmission network excluding the reserved service slice is determined by a following determination method.

Let the weights of other slices in the mine transmission network excluding the reserved service slice be equal to 1, and the calculated total bandwidth of other slices in the mine transmission network excluding the reserved service slice is denoted as B′;
in a case of B′≤(1−n)*B, the total bandwidth of other slices in the mine transmission network excluding the reserved service slice is B′, and bandwidth weights of other slices are all 1.
in a case of B′>(1−n)*B, the bandwidth of each of other slices in the mine transmission network excluding the reserved service slice is calculated according to the following method,
in which, the bandwidth of the i-th slice is Bᵢ, then Bᵢ may satisfy: (1−n)*B=ΣBi, and the size of Bᵢ is determined by the carried service.

In some embodiments, the calculation method of the bandwidth Bᵢ required for the service is: Bᵢ=p*Bwᵢ*nᵢ, where nᵢ is the number of all terminals that form the service, B_{wi} is an average bandwidth of each terminal, P is the bandwidth weight corresponding to the service system, and p is determined according to the priority and importance of the transmission services of the mine system. The greater the weight, the higher the priority of the service. The higher the real-time requirements of the service, the greater the weight; the larger the bandwidth occupied by the service, the smaller its weight.

It should be noted that the weights are divided into Q levels according to whether a type of frequency band used by the system is authorized or unauthorized, and relevance of the service type to safe production, control safety, etc. For example, Q=4. See Table 1 for common service types and weights.

TABLE 1

| Serial | | Weight | |
|---|---|---|---|
| Number | Corresponding system | level | weights |
| 1 | 5G communication system | 1 | p1 = 1 |
| 2 | 4G communication system | | |
| 3 | security monitoring system | | |
| 4 | positioning system | | |
| 5 | broadcasting system | | |
| 6 | dispatching and command | | |
| | system | | |
| 7 | power supply system | | |
| 8 | cellular direct communication | | |
| | system | | |
| 9 | services of all second slices | | |
| 10 | automatic air door system | 2 | p2 = 0.9 |
| 11 | primary conveyor belt system | | |
| 12 | mine pressure monitoring | | |
| | system | | |
| 13 | hydrological monitoring system | | |
| 14 | video monitoring system | 3 | p3 = 0.8 |
| 15 | WIFI communication system | | |
| 16 | other conventional ring network | 4 | p4 = 0.7 |
| | non-security services | | |

In some embodiments, the method further includes: allocating a reserved bandwidth in a bandwidth of a low-latency service slice according to a reliability metric; in which, when reliability metrics of some or all transmission services in the low-latency service slice are greater than or equal to a reliability metric threshold value, the reserved bandwidth is allocated in the low-latency service slice for the transmission services with the reliability metrics greater than or equal to the reliability metric threshold value in the bandwidth of the low-latency service slice; or
allocating a reserved bandwidth in a bandwidth of a large-bandwidth service slice according to a reliability metric; in which, when reliability metrics of some or all transmission services in the large-bandwidth service slice are greater than or equal to a reliability metric threshold value, the reserved bandwidth is allocated in the large-bandwidth service slice for the transmission services with the reliability metrics greater than or equal to the reliability metric threshold value.

It should be noted that for the low-latency service slice and the large-bandwidth service slice, the reserved bandwidth corresponding to the high-reliability transmission service of the slice requires to be additionally implicitly determined.

Additional resources are reserved for high-reliability transmission service demands. The weights of the additional reserved resources are divided according to reliability levels. The additional reserved resources is required to be configured with a certain reserved bandwidth for services with high-reliability transmission demands to perform highly reliable redundant transmission.

In some embodiments, a calculation formula of the reserved bandwidth of the low-latency service slice is provided as:

Rₑ=kₑ*B_{y}*dₑ,
where Rₑ is the reserved bandwidth of the low-latency service slice, kₑ is a weight corresponding to the reserved bandwidth of the low-latency service slice, B_{y} is a bandwidth metric average of transmission services at respective terminals corresponding to the low-latency service slice, dₑ is a number of terminals for transmission services corresponding to the low-latency service slice;
a calculation formula of the reserved bandwidth of the large-bandwidth service slice is provided as:

Rₛ=kₛ*Bᵤ*dₛ
where Rₛ is the reserved bandwidth of the large-bandwidth service slice, kₛ is a weight corresponding to the reserved bandwidth of the large-bandwidth service slice, Bᵤ is a bandwidth metric average of transmission services at respective terminals corresponding to the large-bandwidth service slice, dₛ is a number of terminals for transmission services corresponding to the large-bandwidth service slice.

In some embodiments, the method further includes:
dividing slices of the mine transmission network based on a sub-slot at a data link layer of the mine transmission network.

It should be noted that, as illustrated in FIG. 3, the slicing solution no longer uses Ethernet frames for transmission in the data link, but uses a slot-based scheduling scheme. Each service is transmitted from a terminal A to a terminal B through a switch A, a switch B, and a switch C through a fixed slot.

In the figure, a size of each slot is 5 Gbps, each slot may be subdivided into 5 sub-slots, a size of each sub-slot is 1 Gbps, and each slice may be bound to 1 to N consecutive sub-slots to form a channel with N*1 Gbps bandwidth.

In some embodiments, due to the slot-based scheduling scheme, data of each service is forwarded using sub-slots with fixed numbers, and mapping between data and slots is only performed at a sender and a receiver of data. Other switches in the ring only forward without processing, thereby achieving hard isolation between services.

To sum up, the mine network slicing method proposed in an embodiment may isolate data of respective services, which may not only make the network architecture more concise, but also increase a security performance of the network. Moreover, the slicing function is naturally adapted to the 5G core network slicing function, meets transmission demands of 5G RAN, reduces difficulty of deploying the 5G network, and helps to accelerate intelligent construction of coal mines.

### Embodiment Two

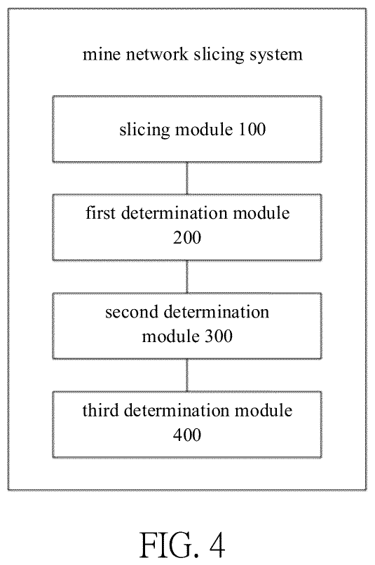

FIG. 4 is a schematic diagram illustrating a first architecture of a mine network slicing system provided in an embodiment of the present disclosure. As illustrated in FIG. 4, the system includes a slicing module 100, a first determination module 200, a second determination module 300 and a third determination module 400.

The slicing module 100 is configured to obtain respective slices corresponding to a mine transmission network by slicing the mine transmission network according to a predetermined slice type, in which, the slice type includes a reserved service slice.

The first determination module 200 is configured to determine a total bandwidth of the mine transmission network.

The second determination module 300 is configured to determine a number of terminals in a service system accessing the mine transmission network and bandwidth metrics of transmission services at respective terminals.

The third determination module 400 is configured to determine a bandwidth of each of the respective slices according to the number of terminals in the service system accessing the mine transmission network and the bandwidth metrics of transmission services at respective terminals, and the total bandwidth of the mine transmission network.

The service system accessing the mine transmission network includes a plurality of terminals.

In some embodiments, the slice type further includes: a low-latency service slice, a large-bandwidth service slice, and an industrial ring network service slice; or
further includes at least one of the low-latency service slice, the large-bandwidth service slice, and the industrial ring network service slice, a high-priority service slice, a high-reliability service slice, a high-coordination service slice or a remote control service slice.

In some embodiments, the service system accessing the mine transmission network includes at least one of:
a mine security monitoring system, a mine video monitoring system, a mine WIFI communication system, a mine 4G communication system, a mine 5G communication system, a mine positioning system, a mine broadcasting system, a mine dispatching and command system, a mine cellular direct communication system, a mine 5G camera system, a mine hydrological monitoring system, a mine pressure monitoring system, a mine automatic air door system, a mine primary conveyor belt system or a mine power supply system.

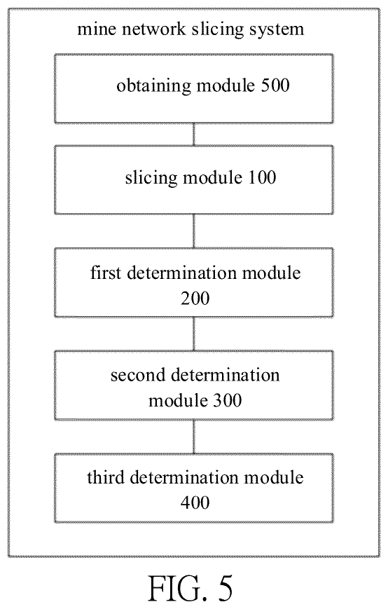

In an embodiment of the present disclosure, as illustrated in FIG. 5, the mine network slicing system further includes an obtaining module 500.

The obtaining module 500 is configured to obtain an upper latency threshold value and a bandwidth demand value of each transmission service corresponding to the service system accessing the mine transmission network in a case that the service system accessing the mine transmission network includes at least one of the mine security monitoring system, the mine video monitoring system, the mine WIFI communication system, the mine 4G communication system, the mine 5G communication system, the mine positioning system, the mine broadcasting system, the mine dispatching and command system, the mine cellular direct communication system, or the mine 5G camera system.

In an embodiment of the present disclosure, the slicing module 100 is specifically configured to:
map a transmission service with an upper latency threshold value of the transmission service less than or equal to a predetermined latency threshold value and a bandwidth demand value of the communication service less than a predetermined bandwidth threshold value in the mine security monitoring system, the mine video monitoring system, the mine WIFI communication system, the mine 4G communication system, the mine 5G communication system, the mine positioning system, the mine broadcasting system, the mine dispatching and command system, and the mine cellular direct communication system to a low-latency service slice;
map a transmission service with a bandwidth demand value of the transmission service greater than or equal to the predetermined bandwidth threshold value and that have not been mapped to the low-latency service slice in the mine video monitoring system, the mine 5G camera system, the mine WIFI communication system, the mine 4G communication system, the mine 5G communication system, the mine-used cellular direct communication system to a large-bandwidth service slice;
map a transmission service that has not been mapped to the low-latency service slice in the mine security monitoring system, the mine hydrological monitoring system, the mine pressure monitoring system, the mine automatic air door system, the mine primary conveyor belt system or the mine power supply system to an industrial ring network service slice;
map an evolved service in the mine transmission network to the reserved service slice.

In some embodiments, the slicing module 100 is further configured to:
map a predetermined service in the mine transmission network to the high-priority service slice, the high-reliability service slice, the high-coordination service slice or the remote control service slice.

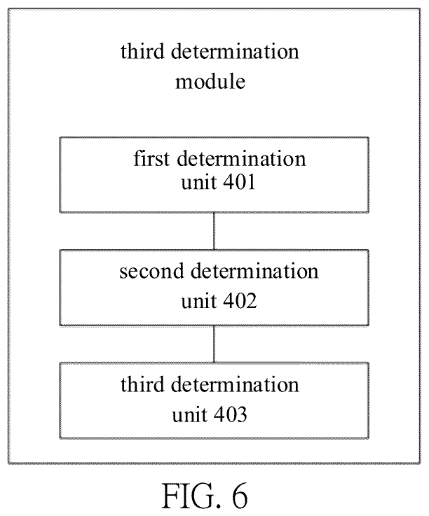

In an embodiment of the present disclosure, as illustrated in FIG. 6, the third determination module 400 includes a first determination unit 401, a second determination unit 402, and a third determination unit 403.

The first determination unit 401 is configured to determine a predetermined bandwidth ratio of the reserved service slice and a predetermined total bandwidth of other slices in the mine transmission network excluding a bandwidth of the reserved business slice.

The second determination unit 402 is configured to determine the bandwidth of the reserved service slice based on the predetermined bandwidth ratio of the reserved service slice and the predetermined total bandwidth of the other slices in the mine transmission network excluding the bandwidth of the reserved service slice.

The third determination unit 403 is configured to determine a bandwidth of each of other slices in the mine transmission network excluding the reserved service slice according to the bandwidth of the reserved service slice, terminal data corresponding to the respective slices, the bandwidth metrics of transmission services at respective terminals and the total bandwidth of the mine transmission network.

The predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

In some embodiments, the second determination unit 402 is specifically configured to:
in response to B′≤(1−n)B, determine that the bandwidth of the reserved service slice is equal to a product of the predetermined bandwidth ratio of the reserved service slice and the total bandwidth of the mine transmission network;
in response to B′>(1−n)B, determine that the bandwidth of the reserved service slice is equal to a difference between the total bandwidth of the mine transmission network and the total bandwidth of the other slices in the mine transmission network excluding the bandwidth of the reserved service slice;
where B′ is the predetermined total bandwidth of the other slices in the mine transmission network excluding the bandwidth of the reserved service slice, n is the predetermined bandwidth ratio of the reserved service slice, B is the total bandwidth of the mine transmission network.

In some embodiments, the third determination unit 403 is specifically configured to:
in response to B′≤(1−n)B, determine the bandwidth of each of the other slices in the mine transmission network excluding the reserved service slice by using a formula

$${B}_{i} = {\sum }_{q = 1}^{Q} {\sum }_{w = 1}^{W} {B}_{q , w} ;$$

in response to B′>(1−n)B, determine the bandwidth of each of the other slices in the mine transmission network excluding the reserved service slice by using a formula

$${B}_{i} = {\sum }_{q = 1}^{Q} {B}_{q} {p}_{q} ;$$

where

$${\sum }_{i = 1}^{I} {B}_{i} = ( 1 - n ) * B ,$$

where Bᵢ is a bandwidth of an i-th slice in the mine transmission network excluding the reserved service slice, B_{q,w} is a bandwidth metric of a transmission service at a w-th terminal in a q-th service system, Q is a total number of service systems in the slice, W is a total number of terminals in one service system, B_{q} is a bandwidth metric average of transmission services at respective terminals in the q-th service system, p_{q} is a weight corresponding to the q-th service system;
in which, the bandwidth metric average is determined based on bandwidth metrics of transmission services at respective terminals.

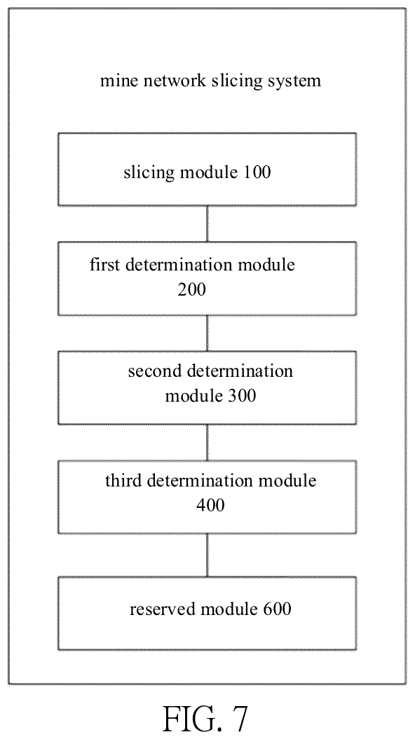

In some embodiments, as illustrated in FIG. 7, the mine network slicing system further includes a reserved module 600.

The reserved module 600 is specifically configured to:
allocate a reserved bandwidth in a bandwidth of a low-latency service slice according to a reliability metric; in which, when reliability metrics of some or all transmission services in the low-latency service slice are greater than or equal to a reliability metric threshold value, the reserved bandwidth is allocated in the low-latency service slice for the transmission services with the reliability metrics greater than or equal to the reliability metric threshold value in the bandwidth of the low-latency service slice; or
allocate a reserved bandwidth in a bandwidth of a large-bandwidth service slice according to a reliability metric; in which, when reliability metrics of some or all transmission services in the large-bandwidth service slice are greater than or equal to a reliability metric threshold value, the reserved bandwidth is allocated in the large-bandwidth service slice for the transmission services with the reliability metrics greater than or equal to the reliability metric threshold value.

A calculation formula of the reserved bandwidth of the low-latency service slice is provided as:

Rₑ=kₑ*B_{y}*dₑ
where Rₑ is the reserved bandwidth of the low-latency service slice, kₑ is a weight corresponding to the reserved bandwidth of the low-latency service slice, B_{y} is a bandwidth metric average of transmission services at respective terminals corresponding to the low-latency service slice, dₑ is a number of terminals for transmission services corresponding to the low-latency service slice;
a calculation formula of the reserved bandwidth of the large-bandwidth service slice is provided as:

Rₛ=kₛ*Bᵤ*dₛ
where Rₛ is the reserved bandwidth of the large-bandwidth service slice, kₛ is a weight corresponding to the reserved bandwidth of the large-bandwidth service slice, Bᵤ is a bandwidth metric average of transmission services at respective terminals corresponding to the large-bandwidth service slice, dₛ is a number of terminals for transmission services corresponding to the large-bandwidth service slice.

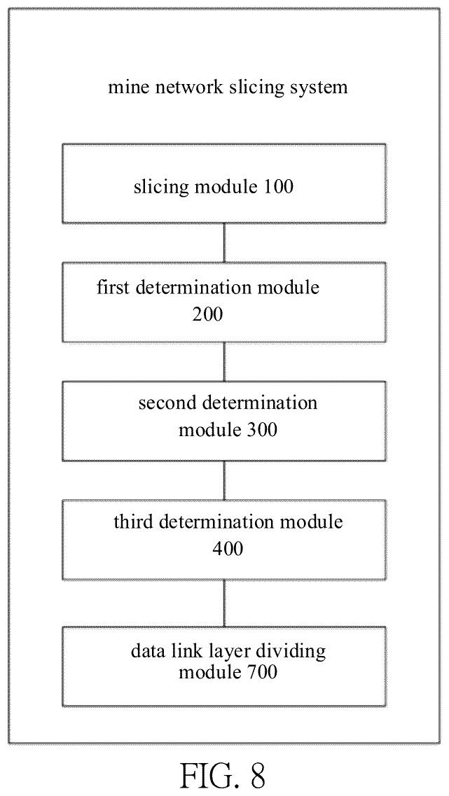

In some embodiments, as illustrated in FIG. 8, the mine network slicing system further includes a data link layer dividing module 700.

The data link layer dividing module 700 is configured to divide slices of the mine transmission network based on a sub-slot at a data link layer of the mine transmission network.

To sum up, the mine network slicing system proposed in an embodiment may map mine network slices based on common hierarchical classification and specific demands to achieve channel isolation, effectively guarantee a transmission performance of high-priority services, and thus help accelerate intelligent construction of coal mines.

According to a third aspect of embodiments of the present disclosure, there is provided an electronic device. The system includes: a memory, a processor and a computer program stored on the memory and capable of being run on the processor, in which, the processor is configured to implement the mine network slicing method as described in any one embodiment in the first aspect when executing the computer program.

According to a fourth aspect of embodiments of the present disclosure, there is provided a computer-readable storage medium storing computer instructions, which cause a computer to implement the mine network slicing method as described in any one embodiment in the first aspect.

The computer-readable medium in an embodiment includes permanent and non-permanent, removable and non-removable media, and information storage can be implemented by any method or technology. Information may be computer-readable instructions, data structures, modules of programs, or other data. Examples of computer storage media include, but are not limited to, a phase-change random access memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a read-only compact disk read-only memory (CD-ROM), a digital versatile disk (DVD) or other optical storage, a magnetic cassette, a magnetic tape, magnetic disk storage or other magnetic storage devices or any other non-transmission media that may be used to store information capable of being accessed by a computing device.

According to a fifth aspect of embodiments of the present disclosure, there is provided a computer program product, including a computer program, which, when executed by a processor, causes the mine network slicing method as described in any one embodiment in the first aspect to be implemented.

According to a sixth aspect of embodiments of the present disclosure, there is provided a computer program, including computer program codes, which cause a computer to implement the mine network slicing method as described in any one embodiment in the first aspect when running on the computer.

It should be noted that the aforementioned explanations and descriptions of the method and system embodiments are also applicable to the electronic device, the computer-readable storage medium, the computer program product and the computer program of the above embodiments, and will not be repeated here.

In descriptions of the specification, descriptions with reference to terms “one embodiment”, “some embodiments”, “examples”, “specific examples” or “some examples” etc. mean specific features, structures, materials or characteristics described in conjunction with the embodiment or example are included in at least one embodiment or example of the present disclosure. In this specification, the schematic representations of the above terms do not have to be the same embodiment or example. Moreover, specific features, structures, materials or characteristics described may be combined in any one or more embodiments or examples in a suitable manner. In addition, those skilled in the art may combine different embodiments or examples and characteristics of different embodiments or examples described in this specification without contradicting each other.

Any process or method descriptions described in the flowchart or in other ways herein may be understood as a module, a segment or a part of a code including one or more executable instructions configured to implement steps of customized logical functions or processes, and scopes of embodiments of the present disclosure include additional implementations, which may include implement functions not be in the order shown or discussed including the substantially simultaneous manner according to functions involved or in reverse order, which should be understood by those skilled in the art of embodiments of the present disclosure.

It should be understood that, notwithstanding the embodiments of the present disclosure are shown and described above, the above embodiments are exemplary in nature and shall not be construed as a limitation of the present disclosure. Those skilled in the art may change, modify, substitute and vary the above embodiments within the scope of the present disclosure.

All embodiments of the disclosure may be executed separately or in combination with other embodiments, and are deemed within a protection scope of the disclosure.

1. A mine network slicing method, comprising:
obtaining respective slices corresponding to a mine transmission network by slicing the mine transmission network according to a predetermined slice type, wherein the slice type comprises a reserved service slice;
determining a total bandwidth of the mine transmission network;
determining a number of terminals in a service system accessing the mine transmission network and bandwidth metrics of transmission services at respective terminals;
determining a bandwidth of each of the respective slices according to the number of terminals in the service system accessing the mine transmission network and the bandwidth metrics of transmission services at respective terminals, and the total bandwidth of the mine transmission network;
wherein the service system accessing the mine transmission network comprises a plurality of terminals;
determining the bandwidth of each of the respective slices according to the number of terminals in the service system accessing the mine transmission network and the bandwidth metrics of transmission services at respective terminals, and the total bandwidth of the mine transmission network comprises: determining a predetermined bandwidth ratio of the reserved service slice and a predetermined total bandwidth of other slices in the mine transmission network excluding a bandwidth of the reserved business slice, determining the bandwidth of the reserved service slice based on the predetermined bandwidth ratio of the reserved service slice and the predetermined total bandwidth of the other slices in the mine transmission network excluding the bandwidth of the reserved service slice, and determining a bandwidth of each of other slices in the mine transmission network excluding the reserved service slice according to the bandwidth of the reserved service slice, terminal data corresponding to the respective slices, the bandwidth metrics of transmission services at respective terminals and the total bandwidth of the mine transmission network, wherein the predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

2. The method according to claim 1, wherein the slice type further comprises: a low-latency service slice, a large-bandwidth service slice, and an industrial ring network service slice; or
further comprises at least one of the low-latency service slice, the large-bandwidth service slice, and the industrial ring network service slice, a high-priority service slice, a high-reliability service slice, a high-coordination service slice or a remote control service slice.

3. The method according to claim 1, wherein the service system accessing the mine transmission network comprises at least one of:
a mine security monitoring system, a mine video monitoring system, a mine WIFI communication system, a mine 4G communication system, a mine 5G communication system, a mine positioning system, a mine broadcasting system, a mine dispatching and command system, a mine cellular direct communication system, a mine 5G camera system, a mine hydrological monitoring system, a mine pressure monitoring system, a mine automatic air door system, a mine primary conveyor belt system or a mine power supply system.

4. The method according to claim 3, wherein, before obtaining the respective slices corresponding to the mine transmission network by slicing the mine transmission network according to the predetermined slice type, the method further comprises:
obtaining an upper latency threshold value and a bandwidth demand value of each transmission service corresponding to the service system accessing the mine transmission network in a case that the service system accessing the mine transmission network comprises at least one of the mine security monitoring system, the mine video monitoring system, the mine WIFI communication system, the mine 4G communication system, the mine 5G communication system, the mine positioning system, the mine broadcasting system, the mine dispatching and command system, the mine cellular direct communication system, or the mine 5G camera system.

5. The method according to claim 4, wherein obtaining the respective slices corresponding to the mine transmission network by slicing the mine transmission network according to the predetermined slice type comprises:
mapping a transmission service with an upper latency threshold value of the transmission service less than or equal to a predetermined latency threshold value and a bandwidth demand value of the communication service less than a predetermined bandwidth threshold value in the mine security monitoring system, the mine video monitoring system, the mine WIFI communication system, the mine 4G communication system, the mine 5G communication system, the mine positioning system, the mine broadcasting system, the mine dispatching and command system, and the mine cellular direct communication system to a low-latency service slice;
mapping a transmission service with a bandwidth demand value of the transmission service greater than or equal to the predetermined bandwidth threshold value and that have not been mapped to the low-latency service slice in the mine video monitoring system, the mine 5G camera system, the mine WIFI communication system, the mine 4G communication system, the mine 5G communication system, the mine-used cellular direct communication system to a large-bandwidth service slice;
mapping a transmission service that has not been mapped to the low-latency service slice in the mine security monitoring system, the mine hydrological monitoring system, the mine pressure monitoring system, the mine automatic air door system, the mine primary conveyor belt system or the mine power supply system to an industrial ring network service slice;
mapping an evolved service in the mine transmission network to the reserved service slice.

6. The method according to claim 2, wherein obtaining the respective slices corresponding to the mine transmission network by slicing the mine transmission network according to the predetermined slice type further comprises:
mapping a predetermined service in the mine transmission network to the high-priority service slice, the high-reliability service slice, the high-coordination service slice or the remote control service slice.

7. The method according to claim 1, wherein determining the bandwidth of the reserved service slice based on the predetermined bandwidth ratio of the reserved service slice and the predetermined total bandwidth of the other slices in the mine transmission network excluding the bandwidth of the reserved service slice comprises:
in response to B′≤(1−n)B, determining that the bandwidth of the reserved service slice is equal to a product of the predetermined bandwidth ratio of the reserved service slice and the total bandwidth of the mine transmission network;
in response to B>(1−n)B, determining that the bandwidth of the reserved service slice is equal to a difference between the total bandwidth of the mine transmission network and the total bandwidth of the other slices in the mine transmission network excluding the bandwidth of the reserved service slice;
where B′ is the predetermined total bandwidth of the other slices in the mine transmission network excluding the bandwidth of the reserved service slice, n is the predetermined bandwidth ratio of the reserved service slice, B is the total bandwidth of the mine transmission network.

8. The method according to claim 7, wherein determining the bandwidth of each of the other slices in the mine transmission network excluding the reserved service slice according to the bandwidth of the reserved service slice, the terminal data corresponding to the respective slices, the bandwidth metrics of transmission services at respective terminals and the total bandwidth of the mine transmission network comprises:
in response to B′≤(1−n)B, determining the bandwidth of each of the other slices in the mine transmission network excluding the reserved service slice by using a formula
$${B}_{i} = {\sum }_{q = 1}^{Q} {\sum }_{n = 1}^{W} {B}_{q , w} ;$$
in response to B′>(1−n)B, determining the bandwidth of each of the other slices in the mine transmission network excluding the reserved service slice by using a formula
$${B}_{i} = {\sum }_{q = 1}^{Q} {B}_{q} {p}_{q} ; where {\sum }_{i = 1}^{l} {B}_{i} = ( 1 - n ) * B ,$$
where Bᵢ is a bandwidth of an i-th slice in the mine transmission network excluding the reserved service slice, B_{q,w} is a bandwidth metric of a transmission service at a w-th terminal in a q-th service system, Q is a total number of service systems in the slice, W is a total number of terminals in one service system, B_{q} is a bandwidth metric average of transmission services at respective terminals in the q-th service system, p_{q} is a weight corresponding to the q-th service system;
wherein the bandwidth metric average is determined based on bandwidth metrics of transmission services at respective terminals.

9. The method according to claim 1, further comprising:
allocating a reserved bandwidth in a bandwidth of a low-latency service slice according to a reliability metric; wherein, when reliability metrics of some or all transmission services in the low-latency service slice are greater than or equal to a reliability metric threshold value, the reserved bandwidth is allocated in the low-latency service slice for the transmission services with the reliability metrics greater than or equal to the reliability metric threshold value in the bandwidth of the low-latency service slice; or
allocating a reserved bandwidth in a bandwidth of a large-bandwidth service slice according to a reliability metric; wherein, when reliability metrics of some or all transmission services in the large-bandwidth service slice are greater than or equal to a reliability metric threshold value, the reserved bandwidth is allocated in the large-bandwidth service slice for the transmission services with the reliability metrics greater than or equal to the reliability metric threshold value.

10. The method according to claim 9, wherein a calculation formula of the reserved bandwidth of the low-latency service slice is provided as:
Rₑ=kₑ*B_{y}*dₑ
where Rₑ is the reserved bandwidth of the low-latency service slice, kₑ is a weight corresponding to the reserved bandwidth of the low-latency service slice, B_{y} is a bandwidth metric average of transmission services at respective terminals corresponding to the low-latency service slice, dₑ is a number of terminals for transmission services corresponding to the low-latency service slice;
wherein a calculation formula of the reserved bandwidth of the large-bandwidth service slice is provided as:
Rₛ=kₛ*Bᵤ*dₛ
where Rₛ is the reserved bandwidth of the large-bandwidth service slice, kₛ is a weight corresponding to the reserved bandwidth of the large-bandwidth service slice, Bᵤ is a bandwidth metric average of transmission services at respective terminals corresponding to the large-bandwidth service slice, dₛ is a number of terminals for transmission services corresponding to the large-bandwidth service slice.

11. The method according to claim 1, further comprising: dividing slices of the mine transmission network based on a sub-slot at a data link layer of the mine transmission network.

12. A mine network slicing system, comprises a memory, a processor and a computer program stored on the memory and capable of being run on the processor, wherein the processor is configured to:
obtain respective slices corresponding to a mine transmission network by slicing the mine transmission network according to a predetermined slice type, wherein the slice type comprises a reserved service slice;
determine a total bandwidth of the mine transmission network;
determine a number of terminals in a service system accessing the mine transmission network and bandwidth metrics of transmission services at respective terminals;
determine a bandwidth of each of the respective slices according to the number of terminals in the service system accessing the mine transmission network and the bandwidth metrics of transmission services at respective terminals, and the total bandwidth of the mine transmission network;
wherein the service system accessing the mine transmission network comprises a plurality of terminals;
the processor is further configured to: determining a predetermined bandwidth ratio of the reserved service slice and a predetermined total bandwidth of other slices in the mine transmission network excluding a bandwidth of the reserved business slice, determining the bandwidth of the reserved service slice based on the predetermined bandwidth ratio of the reserved service slice and the predetermined total bandwidth of the other slices in the mine transmission network excluding the bandwidth of the reserved service slice, and determining a bandwidth of each of other slices in the mine transmission network excluding the reserved service slice according to the bandwidth of the reserved service slice, terminal data corresponding to the respective slices, the bandwidth metrics of transmission services at respective terminals and the total bandwidth of the mine transmission network, wherein the predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

13. (canceled)

14. A computer-readable storage medium storing computer instructions, which cause a computer to implement a mine network slicing method, wherein the method comprises:
obtaining respective slices corresponding to a mine transmission network by slicing the mine transmission network according to a predetermined slice type, wherein the slice type comprises a reserved service slice;
determining a total bandwidth of the mine transmission network;
determining a number of terminals in a service system accessing the mine transmission network and bandwidth metrics of transmission services at respective terminals;
determining a bandwidth of each of the respective slices according to the number of terminals in the service system accessing the mine transmission network and the bandwidth metrics of transmission services at respective terminals, and the total bandwidth of the mine transmission network;
wherein the service system accessing the mine transmission network comprises a plurality of terminals;
determining the bandwidth of each of the respective slices according to the number of terminals in the service system accessing the mine transmission network and the bandwidth metrics of transmission services at respective terminals, and the total bandwidth of the mine transmission network comprises: determining a predetermined bandwidth ratio of the reserved service slice and a predetermined total bandwidth of other slices in the mine transmission network excluding a bandwidth of the reserved business slice, determining the bandwidth of the reserved service slice based on the predetermined bandwidth ratio of the reserved service slice and the predetermined total bandwidth of the other slices in the mine transmission network excluding the bandwidth of the reserved service slice, and determining a bandwidth of each of other slices in the mine transmission network excluding the reserved service slice according to the bandwidth of the reserved service slice, terminal data corresponding to the respective slices, the bandwidth metrics of transmission services at respective terminals and the total bandwidth of the mine transmission network, wherein the predetermined total bandwidth of the other slices in the mine transmission network excluding the bandwidth of the reserved service slice is determined, on the basic of weights of service systems corresponding to the other slices in the mine transmission network excluding the reserved service slice being set as 1, according to the weights and the bandwidth metrics of transmission services at respective terminals.

15. (canceled)

16. (canceled)

17. The system according to claim 12, wherein the slice type further comprises: a low-latency service slice, a large-bandwidth service slice, and an industrial ring network service slice; or
further comprises at least one of the low-latency service slice, the large-bandwidth service slice, and the industrial ring network service slice, a high-priority service slice, a high-reliability service slice, a high-coordination service slice or a remote control service slice.

18. The system according to claim 12, wherein the service system accessing the mine transmission network comprises at least one of:
a mine security monitoring system, a mine video monitoring system, a mine WIFI communication system, a mine 4G communication system, a mine 5G communication system, a mine positioning system, a mine broadcasting system, a mine dispatching and command system, a mine cellular direct communication system, a mine 5G camera system, a mine hydrological monitoring system, a mine pressure monitoring system, a mine automatic air door system, a mine primary conveyor belt system or a mine power supply system.

19. The system according to claim 18, wherein, the processor is further configured to:
before obtaining the respective slices corresponding to the mine transmission network by slicing the mine transmission network according to the predetermined slice type, obtain an upper latency threshold value and a bandwidth demand value of each transmission service corresponding to the service system accessing the mine transmission network in a case that the service system accessing the mine transmission network comprises at least one of the mine security monitoring system, the mine video monitoring system, the mine WIFI communication system, the mine 4G communication system, the mine 5G communication system, the mine positioning system, the mine broadcasting system, the mine dispatching and command system, the mine cellular direct communication system, or the mine 5G camera system.

20. The system according to claim 19, wherein the processor is further configured to:
map a transmission service with an upper latency threshold value of the transmission service less than or equal to a predetermined latency threshold value and a bandwidth demand value of the communication service less than a predetermined bandwidth threshold value in the mine security monitoring system, the mine video monitoring system, the mine WIFI communication system, the mine 4G communication system, the mine 5G communication system, the mine positioning system, the mine broadcasting system, the mine dispatching and command system, and the mine cellular direct communication system to a low-latency service slice;
map a transmission service with a bandwidth demand value of the transmission service greater than or equal to the predetermined bandwidth threshold value and that have not been mapped to the low-latency service slice in the mine video monitoring system, the mine 5G camera system, the mine WIFI communication system, the mine 4G communication system, the mine 5G communication system, the mine-used cellular direct communication system to a large-bandwidth service slice;
map a transmission service that has not been mapped to the low-latency service slice in the mine security monitoring system, the mine hydrological monitoring system, the mine pressure monitoring system, the mine automatic air door system, the mine primary conveyor belt system or the mine power supply system to an industrial ring network service slice;
map an evolved service in the mine transmission network to the reserved service slice.

21. The system according to claim 17, wherein the processor is further configured to:
map a predetermined service in the mine transmission network to the high-priority service slice, the high-reliability service slice, the high-coordination service slice or the remote control service slice.

22. The system method according to claim 12, wherein the processor is further configured to:
in response to B′≤(1−n)B, determine that the bandwidth of the reserved service slice is equal to a product of the predetermined bandwidth ratio of the reserved service slice and the total bandwidth of the mine transmission network;
in response to B′>(1−n)B, determine that the bandwidth of the reserved service slice is equal to a difference between the total bandwidth of the mine transmission network and the total bandwidth of the other slices in the mine transmission network excluding the bandwidth of the reserved service slice;
where B′ is the predetermined total bandwidth of the other slices in the mine transmission network excluding the bandwidth of the reserved service slice, n is the predetermined bandwidth ratio of the reserved service slice, B is the total bandwidth of the mine transmission network.

23. The system according to claim 22, wherein the processor is further configured to:
in response to B′≤(1−n)B, determine the bandwidth of each of the other slices in the mine transmission network excluding the reserved service slice by using a formula
$${B}_{i} = {\sum }_{q = 1}^{Q} {\sum }_{n = 1}^{W} {B}_{q , w} ;$$
in response to B′>(1−n)B, determine the bandwidth of each of the other slices in the mine transmission network excluding the reserved service slice by using a formula
$${B}_{i} = {\sum }_{q = 1}^{Q} {B}_{q} {p}_{q} ; where {\sum }_{i = 1}^{l} {B}_{i} = ( 1 - n ) * B ,$$
where Bᵢ is a bandwidth of an i-th slice in the mine transmission network excluding the reserved service slice, B_{q,w} is a bandwidth metric of a transmission service at a w-th terminal in a q-th service system, Q is a total number of service systems in the slice, W is a total number of terminals in one service system, B_{q} is a bandwidth metric average of transmission services at respective terminals in the q-th service system, p_{q} is a weight corresponding to the q-th service system;
wherein the bandwidth metric average is determined based on bandwidth metrics of transmission services at respective terminals.
